(19) United States
(12) Patent Application Publication
(10) Pub. No.: US 2008/0151252 A1
(43) Pub. Date: Jun. 26, 2008

(54) Seal gum thickness measurement

(75) Inventors: Verner F. Clark, Kennesaw, GA (US); Lisa Clark, Kennesaw, GA (US)

Correspondence Address: FOLEY & LARDNER, 2029 CENTURY PARK EAST, SUITE 3500, LOS ANGELES, CA, 90067, US

(73) Assignee: National Envelope Corporation

(21) Appl. No.: 11/642,291

(22) Filed: Dec. 20, 2006

(51) Int. Cl. G01N 21/47

(52) U.S. Cl. 356/446

(57) ABSTRACT

A method and apparatus for measuring the thickness of flap seal gum on an envelope including establishing parameters for a desired thickness of seal gum and programming such parameters into a programmable logic controller (PLC). Sensing the reflectivity intensity of radiation from the gum thickness on envelopes in a production line and comparing such sensed reflectivity intensity to the parameters for the desired reflectivity intensity as programmed into the PLC. The PLC generates indicia such as alarm signals when the reflectivity intensity sensed does not conform to the preprogrammed parameters. The indicia may include activation of an ink jet sprayer to spray ink on envelopes having gum which does not conform to the preprogrammed parameters.

### BACKGROUND OF THE INVENTION

1. Field of the Invention

This invention relates generally to the manufacture of envelopes on a production line manufacturing apparatus and more particularly to an apparatus and method for measuring the thickness of seal gum at predetermined positions upon the envelope.

2. Description of the Prior Art

Envelope manufacturing machines which fold the closure side and bottom flaps of envelope blanks are well known in the prior art. Such machines which manufacture such envelopes in a production line basis are well known including such apparatus which automatically applies gum to predetermined portions of the envelope blank during the manufacturing process.

A typical process for manufacturing an envelope involves moving a pre-cut sheet of paper stock through a folding apparatus to form panels of the envelope, applying a strip of adhesive or glue (gum) to one or more predetermined locations on the formed panels of the paper stock, completing the folding of the panels to bring the portions with adhesive into contact with other portions of the paper stock, and then moving the folded and glued paper stock through a compression roller to cause the panels to adhere and form a completed envelope. Variations in the quality of the completed envelope occurred due to many reasons including movement or changing an alignment of the adhesive applicator, varying lengths and/or widths of the adhesive strip, incomplete or partial folds on the paper stock, movement of the paper stock and the folding apparatus, pressure variations in the rollers and other parameters.

Seal gum on an envelope is the adhesive that is used to adhere the envelope flap to the body once the envelope is filled. This seal gum is necessary to keep the contents of the envelope inside when the envelope is mailed. If the seal gum is incorrectly applied either in size, thickness or position, then the envelope will not function as designed. This will negatively affect the basic use of the envelope as well as cause problems with inserting equipment and postal sorting equipment. If the thickness of the seal gum is insufficient the envelope flap will not stay closed throughout handling in the postal system. If the seal gum is too thick, the envelopes could stick together during the manufacturing process because the seal gum will not dry to the degree that is required. In addition, if the thickness of the seal gum on the envelope flap is to great, it will stick or jam in the automatic inserting equipment utilized by mass mailers to insert the desired material into the envelope prior to sealing.

Traditional ways to validate the correct positioning of the gum at predetermined points on the envelope blank as well as the thickness of the gum have been visual inspection by holding the envelope to a template or the like or by utilizing a micrometer to measure the thickness of the gum, particularly the gum on the flap of the envelope. Such methods only validate a very small percentage of envelopes at a time and are not capable of being used in line on high speed production equipment utilized in envelope manufacturing. As a result, every envelope produced in such a high speed production manufacturing apparatus cannot be validated through utilization of these prior art measuring techniques.

There is thus need for an apparatus and process which may be utilized in line on high speed envelope production equipment to detect the thickness of the gum particularly on the flap of the envelope to eliminate human operator input and eliminate these possible sources of error and to validate the gum thickness on the seal flap of every envelope being manufactured in such high speed manufacturing equipment.

### SUMMARY OF THE INVENTION

The present invention is directed to a method for measuring the thickness of the flap gum on an envelope including measuring the thickness of flap gum on an envelope to establish the desired thickness, directing a source of radiation toward the measured gum, measuring the reflectivity intensity of the radiation from the established desired thickness to establish a reflectivity intensity for such gum having the desired thickness, providing a programmable logic controller, programming the programmable logic controller with parameters for the established reflectivity intensity, radiating each envelope flap gum in a production line, sensing the reflectivity intensity from the gum on each such envelope and generating a signal representative thereof, comparing said signal with the parameters as programmed into the programmable logic controller, and providing a signal from the programmable logic controller only when the flap gum reflectivity intensity does not conform to the programmed established reflectivity intensity for the flap gum.

The invention is also directed to an apparatus for detecting the thickness of flap gum on an envelope which includes means for directing a source of radiation, toward gum deposited on an envelope, means for sensing the reflectivity intensity of the radiation from the gum on the envelope, means for comparing the sensed reflectivity intensity to a predetermined desired reflectivity intensity from the gum thickness deposited on the envelope flap and means for providing an indicia only when the sensed reflectivity intensity does not conform to the parameters established for the predetermined desired reflectivity intensity.

### BRIEF DESCRIPTION OF THE DRAWINGS

FIG. 1 is a schematic diagram of an envelope upon which the seal gum has been applied;

FIG. 2 is a schematic diagram showing measurement of the thickness of the seal gum on the envelope of FIG. 1;

FIG. 3 is a schematic diagram illustrating sensor measurement of the seal gum thickness;

FIG. 4 is a schematic diagram of a production line upon which the seal gum thickness on the envelope flap is being measured; and

FIG. 5 is a flow chart illustrating the method of measuring seal gum thickness in accordance with the principles of the present invention.

### DETAILED DESCRIPTION

The present invention is directed to an apparatus and method for measuring the presence and thickness of seal gum on the flap of an envelope as it is produced on high speed envelope manufacturing equipment. The thickness of seal gum on the flap of an envelope which is of the desired amount is determined and reflectivity intensity of radiation from that gum thickness is measured to provide parameters representative of that desired thickness. Envelopes coated with flap gum are then passed through high speed production equipment and the thickness of the seal gum is sensed after the application of the seal gum in the production line.

The apparatus for sensing the reflectivity intensity of the radiation is an optical sensor and a rotary encoder connected to and controlled by a programmable logic controller (PLC). The PLC is contained within a housing which includes a touch screen LCD screen manufactured by Maple as part No. HM1530T-006E which serves as an operator interface. Many PLC's are available which will function to control the thickness measurement apparatus of the present invention, however, a preferred PLC is manufactured by Keyence as part KV-24AT. The PLC is programmed to receive the parameters representative of the desired thickness of the flap gum on the envelope. Thereafter, as the envelopes are passed through the high speed equipment, the sensor is utilized to measure the reflectivity intensity of radiation reflected from the flaps of the envelope and then to compare that reflectivity intensity to the parameters as set up in the PLC. The PLC interface includes various input devices and alarms. The input devices are used to program the PLC for the particular envelope manufacturing gum. The alarms notify the operator that the envelope flap gum thickness is out of specification. If the reflectivity intensity does fall within the parameters, then the manufacturing equipment continues to function. If, however, the reflective intensity from the envelope flap gum as detected by the sensor does not fall within the parameters as programmed into the PLC, then the PLC generates signals indicating that the gum thickness does not fall within the desired parameters.

A plain paper envelope with no seal gum reflects a different intensity of the radiation than a spot on the envelope coated with seal gum does. The seal gum is only partially translucent which means that as the thickness of the seal gum changes so does the intensity of the radiation that is reflected. An envelope with a very thin layer of seal gum will very closely resemble the reflectivity intensity of an envelope with no seal gum. As the layer of seal gum gets thicker through the gumming application, the gum gets smoother and more glossy and the reflectivity intensity increases as the gum thickness increases. Thus, by measuring the reflectivity intensity of the radiation from the gum, one can determine the thickness of the seal gum on the envelope and from that compare it to the parameters established in the PLC and ascertain whether or not the seal gum is within the specifications required for the particular envelope being manufactured by the high speed production equipment.

Seal gum thickness is generally measured in thousands of an inch (mils) and varies by paper type and thickness. For example, on a 20 pound white wove paper, the seal gum should be between 0.7 and 1.1 mils in thickness. On a 28 pound rough coated paper the seal gum should be between 1.2 and 1.6 mils in thickness. As one example, to ascertain the parameters to be programmed into the PLC, a layer of gum is applied to 28 pound rough coated paper, is dried, then measured with a micrometer until the gum is 1.2 mils thick. Radiation is directed to the gum and the intensity of the reflectivity is measured by the sensor and recorded. The thickness of the gum is increased to 1.6 mils, dried, and reflectivity intensity is again measured by the sensor and recorded. These lower and upper reflectivity intensities as measured by the sensor and recorded are used to establish the parameters that are programmed into the PLC. The same process is used for other paper stock and desired gum thickness.

During the envelope seal gumming process the envelopes are placed on top of each other but offset enough distance from the seal gum to remain open to the air thus resembling a plurality of shingles. As a result, a continuous surface of envelopes with alternating seal gum and plain paper are moved directly under sensors which are positioned directly over the envelopes and the sensor takes a continuous reading of the reflectivity intensity and the signal generated by the reflective intensity is transmitted to the PLC where that signal is compared to the parameters that have been preprogrammed into the PLC which are representative of the desired thickness of the seal gum on the flap of the envelope.

Referring now to the drawings and more particularly to FIG. 1, there is shown an envelope 50 which includes side flaps 52 and 54 and a bottom flap 56. Also provided is a seal flap 58. As is well known in the manufacturing of envelopes, the side flaps 52 and 54 are folded over the body of the envelope and side flap gum applied thereto. The bottom flap 56 is then folded over and sealed to the side flaps thus leaving the sealing flap 58. As is illustrated, seal gum 20 is applied to the edge of the seal flap 58 so that when contents are inserted into the body of the envelope, the seal gum can be wetted and then sealed to the bottom flap to maintain the contents within the envelope.

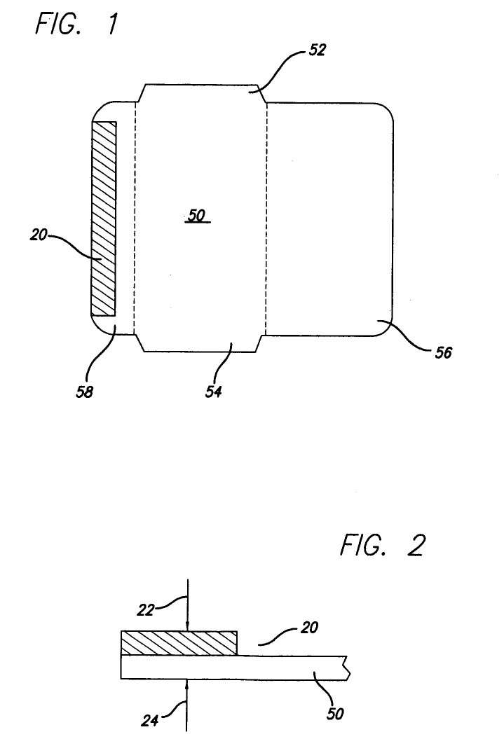

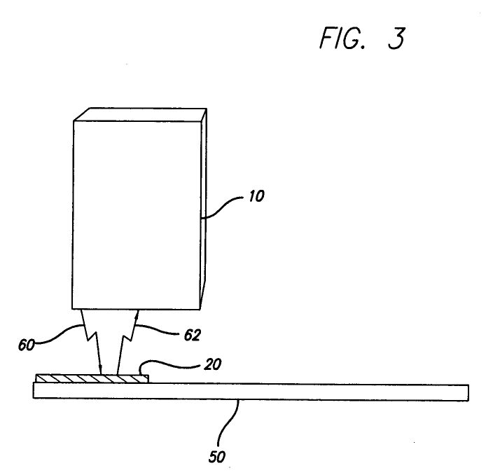

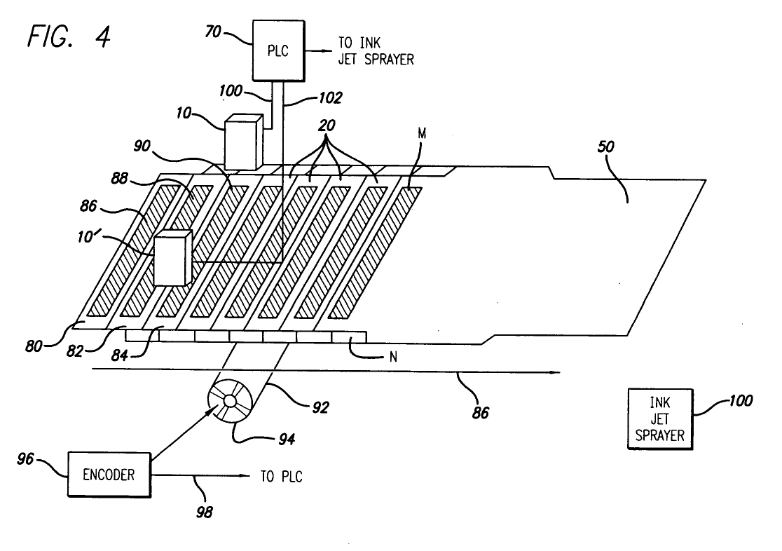

As above indicated, as the thickness of the gum applied to the envelope increases, the reflectivity intensity of radiation directed toward the envelope and the gum increases. As above indicated, standards have been established as to the desired thickness of the gum on the seal flap of the envelope so that the envelope when manufactured will function in accordance with the desired specifications and with the subsequent converting equipment utilized in the postal process. As is shown in FIG. 2, when seal gum 20 has been applied to the envelope paper 50 a measuring device such as a micrometer illustrated by the arrows 22 and 24 may be utilized to measure the thickness of the seal gum on the envelope. When the seal gum thus measured is of the thickness desired for the particular envelope being manufactured, the seal gum is subjected to radiation as illustrated in FIG. 3. The radiation 60 is directed toward the seal gum 20 and the intensity of the radiation as reflected as illustrated at 62 is then measured by the sensor 10. The sensor 10 is preferably a Luster Detection Sensor manufactured by Keyence having a main amplifier CZ-V21A and sensor head CZ-H72. Radiation in the form of white light is directed toward the envelope flaps. The radiation reflectivity intensity is measured by the sensor and as a result there is determined parameters that match the desired thickness as measured by the micrometer as above described. Those parameters are then programmed into a programmable logic controller (PLC) 70 as is shown in FIG. 4. The operator when making the insertion of the parameters will establish appropriate tolerances which are acceptable in the envelope manufacturing industry for the particular envelope being manufactured on the high speed production equipment.

Referring now more particularly to FIG. 4, there is a schematic representation of the seal gum thickness measuring apparatus in accordance with the principles of the present invention. As is therein shown, a plurality of envelopes 80, 82, 84-N are passed in a direction as shown by the arrow 86 through the manufacturing apparatus after seal gum 86, 88, and 90-M have been applied to the seal flap of the envelopes. As was described above, the envelopes are positioned like a continuous line of shingles with just the flaps having the seal gum thereon being exposed as they pass through the equipment. As is illustrated, there is involved a wheel 82 having a plurality of optical marks 94 positioned thereon. An optical encoder 96 senses the passage of the optical marks 94 as the shaft 92 rotates and generates a signal which is representative of the position of the shaft as it rotates. That signal is coupled by a coupling apparatus 98 to the PLC 70 which senses the position of the envelopes in the manufacturing process. A pair of sensors 10 and 10′ are positioned directly over the seal gum. Each of the sensors directs a column of radiation to the seal gum and the sensor then detects the reflectivity intensity of the radiation from the seal gum. As the envelopes pass under the sensors there are alternating areas of plain paper and gum. The PLC is programmed to recognize these alternating areas through the use of counts generated by the optical encoder. A signal is generated by the sensors which is then passed over the coupling apparatus 100, 102 to the PLC. These signals are compared to the parameters previously programmed into the PLC. As above described, if those signals generated by the sensors are within the parameters previously programmed, the system continues to operate with nothing happening other than the envelopes passing through the system. However, if the thickness of the seal gum is either too thin or too thick thus falling outside of the parameters which have been preprogrammed into the PLC 70, the PLC 70 will generate indicia to alert the operator that the seal gum thickness is out of specification.

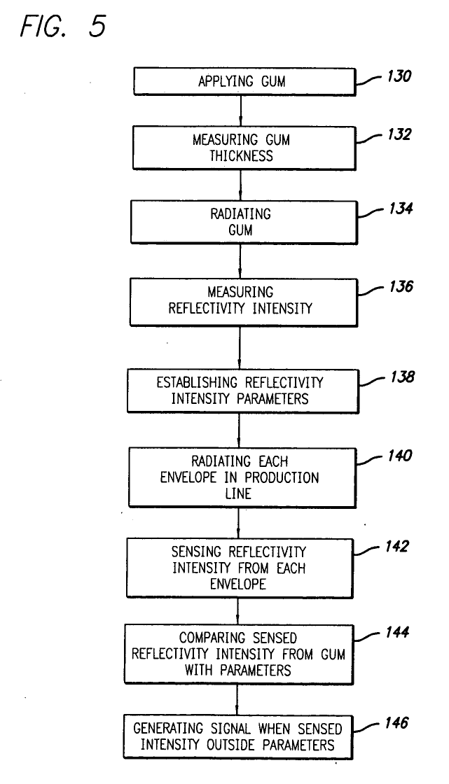

Referring now more particularly to FIG. 5, there is a flow chart illustrative of the method of measuring the seal gum thickness in accordance with the principles of the present invention. As is illustrated at 130 seal gum is applied to a surface of paper which is of the type to be utilized for a particular envelope that is to be manufactured. At 132 there is illustrated the fact that the thickness of the gum that has been applied is measured. That measuring step is typically done on a manual basis with the utilization of a micrometer or other similar thickness measuring devices. Once the thickness of the gum is determined to be within the tolerances desired for the particular envelope to be manufactured then the gum is radiated as shown at 134. That is a column or beam of radiation such as light at a desired frequency is directed toward the gum having the desired thickness. The reflectivity of the intensity from the radiated gum is then measured as shown at 136. Through this measuring a set of parameters are established which are representative of the desired reflectivity intensity as is shown at 138. The parameters as established then provide a basis for determining whether or not the envelopes passing through the production equipment meet the desired specifications. As above indicated, this can be accomplished through utilization of the PLC 70 by programming the same to have the desired parameters for the thickness of the gum on the envelope to be manufactured. Thereafter as shown at 140, the gum applied to each envelope manufactured in the high speed production equipment is then radiated with the light of the desired frequency. The reflectivity intensity of that light is then sensed as shown at 142. As shown at 144, the sensed reflectivity intensity from the gum is compared with the parameters which have been established as illustrated at 138. As long as the sensed reflectivity intensity from the gum is within the parameters previously established and programmed into the PLC, nothing occurs. If, however, the sensed reflectivity intensity falls outside those parameters, then as illustrated at 146 a signal is generated which will alert the operator that the gum on the envelope is outside the desired parameters. When such occurs, an appropriate signal is generated as above indicated and it may, for example, illuminate one of the lights appearing on the operator interface or alternatively, may provide an audible signal to the operator that there has been sensed an envelope or a plurality of envelopes which do not fall within the desired parameters. In addition, there may be provided as part of the manufacturing equipment an ink jet sprayer 100 which will be applied to envelopes that do not meet the seal gum thickness parameters. When such a device is utilized, it is located at the delivery end of the envelope manufacturing machine and positioned just prior to the collating step thereof. The ink jet sprayer is connected to the PLC and when the PLC detects an envelope with seal gum outside of the specification it activates the ink jet sprayer 100 to spray ink on that envelope. The signal is delayed by an amount of envelopes equal to the length of the machine between the sensor and the ink jet sprayer. That delay time is input by the operator through the PLC at the time the system is initially set up. Envelopes with ink spray on them are removed from the rest of the product by the operator.

A method for detecting flap gum thickness on an envelope and for comparing the flap gum thickness to a preprogrammed set of parameters which are indicative of the appropriate thickness of the gum on the envelope and when that gum thickness envelope does not meet those parameters to provide an appropriate alarm to an operator to remove those envelopes in which the flap gum thickness is not in accordance with the parameters previously programmed. This system is capable of inline operation at a layer speed of up to 1500 feet per minute during the envelope manufacturing process. The sensors operate continuously and by the ability to detect the reflectivity intensity of the radiation illuminating the gum can detect the thickness thereof and detect an out of specification envelope at operational speeds and generate an alarm and/or spray ink on the out of specification envelope(s) so they may be removed.

What is claimed is:

1. The method of measuring the thickness of flap gum on an envelope to establish the desired thickness thereof comprising:
applying gum to paper;
measuring the thickness of the gum to establish a desired thickness thereof;
radiating the gum;
measuring the reflectivity intensity of radiation from the established desired thickness to establish reflectivity intensity parameters for such desired thickness;
providing a PLC;
programming the PLC for the established reflectivity intensity;
radiating each envelope flap gum in a production line for manufacturing envelopes;
sensing the reflectivity intensity from the gum on each envelope and generating a signal representative thereof;
comparing said reflectivity intensity from the gum in the production line with the reflectivity intensity parameters as preprogrammed into the PLC; and
providing a signal from the PLC only when the flap gum reflectivity intensity does not conform to the preprogrammed established parameters for the desired reflectivity intensity.

2. The method as defined in claim 1 wherein the measuring of the gum thickness to establish the desired thickness is done manually.

3. The method as defined in claim 2 wherein the measuring is done with a micrometer.

4. The method as defined in claim 1 further comprising providing an optical encoder to determine the position in a production line of envelopes.

5. The method as defined in claim 1 further comprising providing an ink jet sprayer coupled to said PLC, activating said ink jet sprayer to spray ink on envelopes when said gum thickness does not conform to the preprogrammed parameters.

6. Apparatus for measuring the thickness of gum on an envelope comprising:
means for directing radiation toward gum deposited on an envelope;
means for sensing the intensity of the radiation reflected from said gum;
means for comparing the intensity of the reflected radiation to a preset parameter representative of the desired gum thickness; and
means for generating an out of parameter indicia when the reflected radiation intensity is outside said preset parameter.

7. Apparatus as defined in claim 6 wherein said means for directing radiation comprises a source of white light.

8. Apparatus as defined in claim 6 wherein said means for sensing comprises a light sensor disposed over said envelope.

9. Apparatus as defined in claim 6 wherein said means for comparing comprises a programmable logic controller.

10. Apparatus as defined in claim 9 wherein said means for generating comprises an ink jet sprayer coupled to said programmable logic controller.

11. Apparatus as defined in claim 8 wherein said means for directing radiation comprises a source of light contained in said light sensor and disposed over said gum.
